(19) United States
(12) Patent Application Publication
(10) Pub. No.: US 2005/0201761 A1
(43) Pub. Date: Sep. 15, 2005

(54) SINGLE FIBER TRANSCEIVER with FAULT LOCALIZATION

(75) Inventors: Meir Bartur, Los Angeles, CA (US); Jim Stephenson, Thousand Oaks, CA (US)

Correspondence Address: OPTICAL ZONU CORPORATION, 15028 DELANO STREET, VAN NUYS, CA, 91411, US

(73) Assignee: OPTICAL ZONU CORPORATION, Van Nuys, CA (US)

(21) Appl. No.: 10/711,232

(22) Filed: Sep. 2, 2004

Related U.S. Application Data
(60) Provisional application No. 60/500,573, filed on Sep. 5, 2003.

(51) Int. Cl. H04B 10/04

(52) U.S. Cl. 398/197

(57) ABSTRACT

A fiber optic transceiver adapted for use in an optical fiber data transmission system is capable of detecting reflection problems in fiber optic links and providing information related to the distance to the point of reflection. The fiber optic transceiver contains a fiber interface, a receiver, a transmitter, and a microcontroller. The microcontroller controls the transmitter to modulate the laser power to transmit impulse test data and the transceiver includes circuitry and microcode to detect reflection due to fiber connection problems. This enables trouble shooting during installation and/or reconfiguring the connection automatically, in response to a connection problem, and provides a physical layer link.

### RELATED APPLICATION INFORMATION

The present application claims priority under 35 USC 119 (e) of provisional application Ser. No. 60/500,573 filed Sep. 5, 2003, the disclosure of which is incorporated herein by reference in its entirety.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers” when a single unit contain both a transmitter and a receiver) that provide the interface between the electronic circuitry and the fiber optic link. The transceivers are deployed throughout the fiber optic distribution network, at each end of a fiber optic strand. An important feature of a fiber optic network is the ability to keep the operations of such network uninterrupted, and in cases of failure to minimize the repair time. As fiber distribution networks become widely deployed the instances of inadvertent fiber break increases. For example, such break can be due to construction of a trench somewhere on the fiber route resulting in unintentional cut of the fiber trunk. Once such cut, or fiber break, occurs the service is disrupted and the network operator is faced with the task to quickly and efficiently isolate the problem and physically locate the area where the fiber is cut. Another type of problem can occur for fiber systems occurs where the connections between the transceivers and the optical network is done via “patch panel” that contains an array of fiber-optic receptacle and plugs that enable connections to be configured by an operator. At times adding or reconfiguring another link may result in an operator error and the wrong fiber is unplugged from the panel. Service is interrupted and it is not always clear at what end of the link such a mistake took place.

Determining connection problems where fiber disruption is located may involve considerable time and inconvenience to the operator of the network. Current practice deploys skilled technicians and/or engineers that physically go to the fiber termination point and using expensive test equipment localizing the problematic spot. The equipment usually deployed is Optical Time domain Reflectometer (OTDR) that characterizes all the reflections along an optical path, and locate them based on timing/propagation measurements. Since fiber break is associated with an increase in the optical power reflected at the break point due to diffraction at the glass to air interface, such an OTDR is used to find the distance to the failure point. Only than a repair crew can be dispatched to the actual area of failure. Therefore, it will be appreciated that these difficulties related to faults localization in an optical network can waste considerable time and generate associated expenses related to maintenance and system downtime.

The common fiber-optic link utilizes two fibers such that each transceiver couples its transmitter optical output to one fiber and receives the optical signal via another fiber. Single fiber transceivers couple both streams of traffic (incoming and outgoing) over a single fiber strand. Accordingly, it will be appreciated that a need presently exists for a single fiber optical transceiver which can address the above noted problems. It will further be appreciated that a need presently exists for such an optical transceiver which can provide such capability without significant added cost or complexity.

### SUMMARY OF THE INVENTION

The present invention provides a single fiber optical transceiver adapted for use in an optical fiber transmission system which is capable of detecting and localizing open fiber connector connection and incidents of high optical return loss (ORL) usually associated with fiber break. The present invention further provides an optical transceiver which can provide such capability without added cost or complexity.

In a first aspect the present invention provides an optical transceiver coupled to single optical fiber. The transceiver, comprising a transmitter comprising a laser diode and a laser driver providing a drive signal to the laser diode, a receiver comprising a photodiode and signal recovery circuitry, and a microcontroller coupled to the transmitter and receiver and providing a pulsed power control signal to the laser driver during a special test mode operation to transmit an impulse of optical power into the fiber and monitoring received signals on the same fiber to detect incidents of high optical reflectance.

In a preferred embodiment, the laser driver has modulation and bias power control inputs and the microcontroller controls the bias control input during said test mode. For example, the microcontroller may set the bias power control and the modulation control to the maximum the laser driver can provide hence generating the highest possible optical power from the laser driver. The receiver preferably includes a transimpedance amplifier coupled to the photodiode and the microcontroller monitors the output of the transimpedance amplifier using a comparator during the test mode. The comparator detects an incoming light impulse and provides a first output when the transimpedance amplifier output is above a threshold value and a second output when it is below the threshold value. Preferably, the transmitted impulse has a fast rise-time so the received test signal also has a sharp rise time. The microcontroller monitors the time difference between the transmitted impulse and the received impulse. Knowledge of the propagation time of light in an optical fiber (e.g. 5 nSec per meter) can be used to localize the distance to the reflection point.

In a further aspect the present invention provides a fiber optic communication network, comprising an optical fiber and a transceiver coupled to the single optical fiber. The transceiver comprises a transmitter including a laser diode coupled to a single fiber and a laser driver providing a drive signal to the laser diode, and an additional transistor that can increase the impulse current to the laser diode, a receiver including a photodiode coupled to a single fiber and signal recovery circuitry, and a microcontroller coupled to the transmitter and receiver and providing a modulated and bias power control signals to the laser driver and the additional transistor during an impulse transmit pulse and monitoring received signals to detect returned impulse. Preferably the additional transistor is coupled to the bias supply line to the laser, thus not interfering with the required high frequency response of the modulation signal during normal data transport.

In a preferred embodiment, the impulse test mode is combined with a smart transceiver with a state machine (see U.S. patent application Ser. No. 10/304,393 the disclosure of which is incorporated herein by reference in its entirety). When the state machine detects an abnormal operation condition it initiates the sending of the impulse power and monitoring the time the reflected impulse is received, as described above.

In another preferred embodiment, the threshold of the receiver comparator is adjusted by the microcontroller to enable sensitivity control of the reflected impulse detection.

In another preferred embodiment, the timing information of the difference between the sent impulse time and the received impulse time is stored in data fields in memory page of the microcontroller, accessible to the system via electrical interface.

In another preferred embodiment, the microcontroller responds to received impulse only within a predetermined time window. By changing the time window allowing for reflectance monitoring, multiple reflection points can be identified.

Further features and advantages will be appreciated from a review of the following detailed description of the invention.

### BRIEF DESCRIPTION OF THE DRAWINGS

FIG. 1 is a block schematic drawing of a fiber optic data transmission system in accordance with the present invention.

FIG. 2 is a block schematic drawing of a transceiver coupled to a single optical fiber in accordance with the present invention.

FIG. 3 is a block schematic drawing of a microcontroller employed in the transceiver of FIG. 2, in accordance with a preferred embodiment of the present invention.

FIG. 4 is a block schematic drawing of a transceiver coupled to a single optical fiber in accordance with a preferred embodiment of the present invention present invention, enabling higher current impulse.

FIG. 5 is a block schematic drawing of a transceiver coupled to a single optical fiber in accordance with a preferred embodiment of the present invention present invention, enabling threshold control for detecting impulse response.

### DETAILED DESCRIPTION OF THE INVENTION

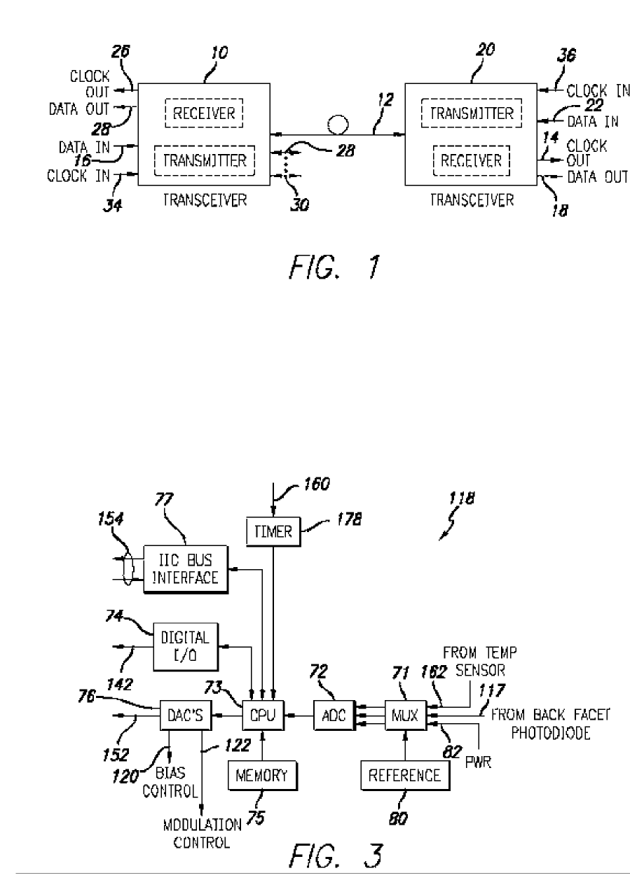

Referring to FIG. 1, a high-level block schematic drawing of a fiber optic data transmission system incorporating the present invention is illustrated.

As shown in FIG. 1, a first transceiver 10 is coupled to a second transceiver 20 via optical fiber 12. Both transceiver 10 and transceiver 20 include transmitter circuitry to convert input electrical data signals to modulated light signals coupled into fiber and receiver circuitry to convert optical signals provided along the optical fibers to electrical signals and to detect encoded data and/or clock signals. As indicated by the arrows on the optical fiber 12, transceiver 10 transmits data to transceiver 20 in the form of modulated optical light signals along optical fiber 12 and also receives optical signals from transceiver 20 along the same fiber 12. For example, single wavelength may be employed and both transceivers may transmit and receive at the same wavelength. Alternatively transmission in the two directions may be provided in different wavelength or in accordance with time division multiplexing or using other protocols. This bidirectional transmission along a single fiber is referred to herein as a single fiber system even though a given transceiver may be coupled to more than one transceiver and may therefore employ more than one fiber, as indicated generally by plural fibers 28-30.

More specifically referring to FIG. 1, input electrical data signals, either differential or single ended, are provided along line 16 from outside data source as well as optional clock signal 34 to transceiver 10 for transmission to transceiver 20 as modulated light signals. Transceiver 20 in turn receives the light pulses, converts them to electrical signals and outputs data and optional clock signals along lines 18 and 14, respectively. Transceiver 20 similarly receives input electrical data signals along line 22 and optional clock along line 36, converts them to modulated light signals and provides the modulated light signals along fiber 12 to transceiver 10. Transceiver 10 receives the modulated light pulses, converts them to electrical signals and derives clock (optional) and data signals which are output along lines 26 and 28, respectively. Also, the clock inputs along lines 34 and 36 may be provided in a synchronous system in to improve jitter performance of the transmitters, but are not necessary. The clock outputs along lines 26 and 14 are not necessary. It will further be appreciated that additional fiber coupling along fibers 28-30 to additional transceivers may also be provided for various applications and architectures and such additional transceivers are implied herein as part of an overall system.

In various applications data transmission along the optical fibers may be in burst mode or both burst and continuous modes at different times. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 28-30 in FIG. 1. For a PON system, the fibers are combined external to the transceiver. The number of such connections is of course not limited to those illustrated and transceiver 10 could be coupled to a large number of separate optical networking units in a given application, and such multiple connections are implied herein.

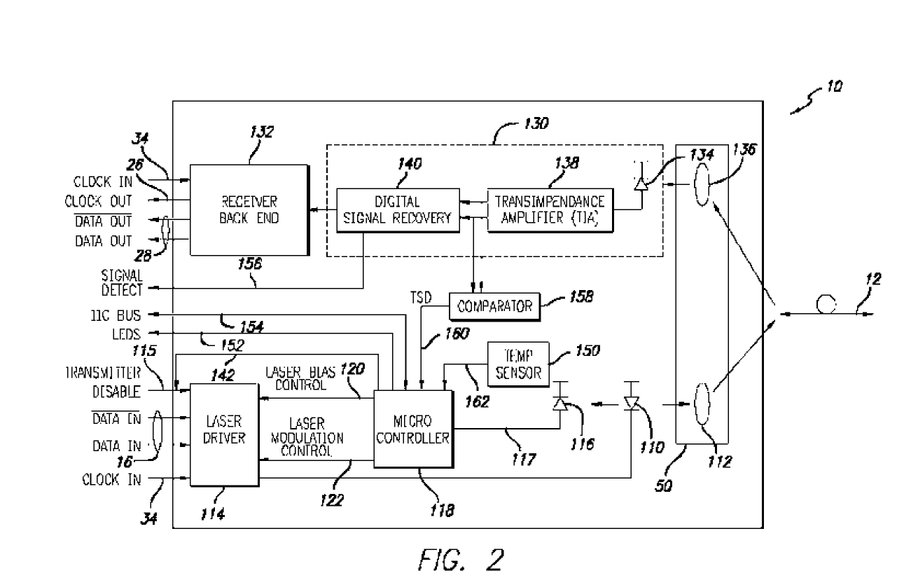

Referring to FIG. 2, a block schematic drawing of a transceiver coupled to a single optical fiber 12 in accordance with the present invention is illustrated. The transceiver illustrated in FIG. 2 may correspond to either transceiver 10 or 20 illustrated in FIG. 1 or another transceiver in the network although it is denoted by reference numeral 10 in FIG. 2 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated in FIG. 2, the transmitter portion of transceiver 10 includes a laser diode 110 which is coupled to transmit light into optical fiber 12. Optics 50 is adapted to deliver modulated light to fiber 12 from the transmitter portion of transceiver 10 and to provide incoming modulated light from fiber 12 to the receiver portion. The optics 50 is generally illustrated schematically in FIG. 2 by first and second lenses 112, 136, however, optics 50 may include beams splitters to split the beam of light corresponding to the transmit and receive directions in a single wavelength implementation of the single fiber transceiver. (See U.S. application Ser. No. 09/836,500 filed Apr. 17, 2001 for OPTICAL NETWORKING UNIT EMPLOYING OPTIMIZED OPTICAL PACKAGING, the disclosure of which is incorporated herein by reference in its entirety).

Laser diode 110 is coupled to laser driver 114 which drives the laser diode in response to the data input provided along lines 16 to provide the modulated light output from laser diode 110. In particular, the laser driver provides a modulation drive current, corresponding to high data input values (or logic 1), and a bias drive current, corresponding to low data input values (or logic 0). During normal operation the bias drive current will not correspond to zero laser output optical power. Various modulation schemes may be employed to encode the data, for example, NRZ encoding may be employed as well as other schemes well known in the art. In addition to receiving the data provided along lines 16 the laser driver 114 may receive a transmitter disable input along line 115 as illustrated in FIG. 2. This may be used to provide a windowing action to the laser driver signals provided to the laser diode to provide a burst transmission capability in a transmitter adapted for continuous mode operation to thereby provide dual mode operation. The microcontroller 118 may disable the laser driver 114 via line 142 to enable reception without potential cross talk with the transmitted signal. During the test mode the transmitter disable blocks and effect of external data 16 on the output of the laser driver 114. The laser driver 114 may also receive a clock input along line 34 which may be used to reduce jitter in some applications. As further illustrated in FIG. 2, a back facet monitor photodiode 116 is preferably provided to monitor the output power of laser diode 110. The laser output power signal from back facet monitor photodiode 116 is provided along line 117 to microcontroller 118 which adjusts a laser bias control input to the laser driver 114 and a laser modulation control input to the laser driver 114, along lines 120 and 122, respectively. Microcontroller 118 may also receive a temperature signal from temperature sensor 150 which monitors the internal temperature of the transceiver and connects to the microcontroller 118 via line 162. This temperature reading can be used to compensate the laser bias current and modulation current with changes in temperature. The modulation and bias control signals thus allow the laser driver 114 to respond to variations in laser diode output power, which power variations may be caused by temperature variations, aging of the device circuitry or other external or internal factors. This allows a minimum extinction ratio between the modulation and bias optical power levels, e.g., 10 to 1, to be maintained. To allow rapid response to the modulation and bias control signals preferably a high speed laser driver is employed. For example, a Vitesse VSC7923 laser driver or other commercially available high speed laser driver could be suitably employed for laser driver 114. Microcontroller 118 also has an interface 154 to transfer and receive test, maintenance and transceiver ID data to and from the user. Microcontroller 118 can also provides visual status indications, e.g., to LEDs, along lines 152. Interface 154 may, for example, be a serial IIC interface bus. The functions of microcontroller 118 will be described in more detail below in relation to the discussion of the microcontroller block diagram of FIG. 3.

Still referring to FIG. 2, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 134 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform. A suitable digital signal recovery circuit is disclosed in co-pending U.S. patent application entitled “Fiber Optic Transceiver Employing Front End Level Control”, to Meir Bartur and Farzad Ghadooshahy, Ser. No. 09/907,137 filed Jul. 17, 2001, the disclosure of which is incorporated herein by reference. When the digital signal recovery circuit 140 detects the digital waveform of an incoming signal an output signal detect (SD) signal is provided along line 156, which may provide an indication of a received signal for the user. A second signal detect (Test Signal Detect—TSD) signal which is used only internally is detected by comparator 158 which is coupled to the differential output of transimpedance amplifier 138. This signal TSD is provided to microcontroller 118 via line 160 and used in a manner described in detail below. It is also possible to connect the signal detect (SD) signal provided along line 156 to the microcontroller 118 and provide an alternative output from the microcontroller 118 that combines the information received from SD and TSD. Commercially available post amplifiers (e.g. Philips TZD 3044) can act as the digital signal recovery 140, and provide a signal detect output 156. If the signal detect provided is fast enough (e.g. 1 μSec) the signal can replace the TSD and eliminate the need for the dedicated comparator 158. The output TSD is valid when the light intensity is above a preset threshold and is invalid when the light intensity is below this threshold. As discussed below, this threshold may optionally be varied under the control of microcontroller 118 in which case microcontroller 118 will have a control line 161 in FIG. 5 coupled to comparator 158. The comparator circuit may include a hysteresis circuit to limit oscillation at the transition between the valid and invalid state. This comparator circuit is used to process low frequency test data as discussed in U.S. patent application Ser. No. 10/304,393 and is also used to detect reflected light impulse as described in more detail below.

The digital signals output from digital signal recovery circuit 140 are provided to the back end of the receiver 132 which removes signal jitter, for example using a latch and clock signal to remove timing uncertainties, and which may also derive the clock signal from the digital signal if a clock signal is desired. In the latter case the receiver back end 132 comprises a clock and data recovery circuit which generates a clock signal from the transitions in the digital signal provided from digital signal recovery circuit 140, for example, using a phase locked loop (PLL), and provides in phase clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock may be available locally and the back end 132 aligns the phase of the incoming signal to the local clock, such that signals arriving from different transmitters and having differing phases are all aligned to the same clock. In this case the clock signals are inputs to the receiver back end from the local clock provided along line 34. A suitable clock and data phase aligner for such a synchronous application is disclosed in co-pending U.S. patent application entitled “Fiber Optic Transceiver Employing Clock and Data Phase Aligner”, to Meir Bartur and Jim Stephenson, Ser. No. 09/907,057 filed Jul. 17, 2001, the disclosure of which is incorporated herein by reference.

Referring to FIG. 3, a block schematic drawing of the microcontroller 118 is shown. As discussed briefly above, the microcontroller sets the laser bias and modulation current, monitors the laser bias and modulation current, monitors the back facet photo diode current along line 117, power supply voltage along line 82, and communicates with the user through a IIC bus and visual status lights operated through the either the digital I/O 74 or output 152 from the DACs. These functions are performed by executing suitable program code in CPU 73. The microcontroller 118 may also contain an identification stored in memory 75 that can be read by the user through the IIC interface (e.g., 128 bytes of data).

More specifically, the microcontroller 118 sets the bias current and modulation current by setting the digital values of the digital to analog converters (DACs) 76. The analog output values set the bias and modulation set point voltages for the laser driver 114. The power may be factory set or user settable through the IIC bus. The DACS may be implemented as pulse width modulators (PWM). During data transport operation, for example, the microcontroller will automatically adjust the bias and modulation set point voltages to adjust for variations in laser power with changes in temperature. During the manufacture of the transceiver, the transmitter is characterized by measuring the laser output power over temperature and storing this information in the microcontroller memory 75. The microcontroller uses this information to determine the set points for any particular temperature.

U.S. patent application Ser. No. 10/304,393 describes how the microcontroller 118 can transmit pulse width modulated data by changing the bias set point between 0 power and maximum bias power by controlling the digital to analog converter. The far end receiver then receives this data where it is fed to the microcontroller through the comparator 158. The comparator output high thus represents a test signal detect (TSD) which can be modulated to transfer test data and is used only internally. For pulse width modulated test data the timer 178 within the microcontroller measures the pulse width of the TSD signal and determines if the data is a one or a zero. During normal operation the output of the comparator is always at a valid logic level as the input optical power provided by the remote transmitter results in a signal that is above the set point of the comparator even for the weakest input signal.

Optical networks sometimes suffer from imperfect connections that are characterized by increased loss in the connection and reflecting some portion of the light back to the transmitter. An open connector (glass to air interface) results in ˜14.5 dB ORL (Optical Return Loss—the measure of the amount of power reflected back in dB). Operating a single fiber single wavelength link may have instances during testing or installation when the link is open—resulting in an open connector. Fiber break can result in an incidence of high ORL e.g. 15-20 dB. The ability to detect such a reflection and pin-point the location can be very useful in keeping fiber networks operational.

One particular advantage of the test mode processing described herein pertains to reflection location localization. Reflections are a very significant problem for single fiber single wavelength links where the transmitted wavelength and the received wavelength are traveling on the same fiber, and the receiver is sensitive to the same wavelength as the transmitter (duplex operation).

Once the transceiver is in a fault isolation mode, due to a particular conditions detected by a state machine (for example see U.S. patent application Ser. No. 10/304,393) or when controlled by the user via the IIC interface, the transceiver can provide coarse measurement of the location of high ORL point. By sending a short pulse and monitoring the comparator 158 (issuing an interrupt in the microcontroller 118) the transceiver can measure the round trip delay to the fault. For example a microcontroller 118 operating at 4 MHz clock can detect the reflection within accuracy of similar or better that 4 clock units. The propagation speed of light in the fiber is ˜200 m/ μSec. A round trip delay of 1 μSec (4 clock cycles) represents a fault at 100 m from the source. The timing information, translated to distance, can also be made available via the IIC interface 77 to a host or other higher layer of the system. By measuring internal delays of the components during fabrication those delays can be offset from the raw time difference for increased accuracy. Also, repeating the measurement multiple times and averaging the result can be utilized to increase accuracy and repeatability. For application requiring a finer resolution of distance location microcontroller 118 operating at a higher clock rate would provide better resolution (e.g. 40 MHz clock can yield 10 m or better resolution). Alternatively a dedicated counter can be set with a clock rate higher than the microcontroller, whose start count signal is received from the microcontroller at the impulse transmit, and stop signal is received from the comparator 158. The microcontroller can read the counter and provide the location information at much higher resolution without incurring the cost of high speed microcontroller.

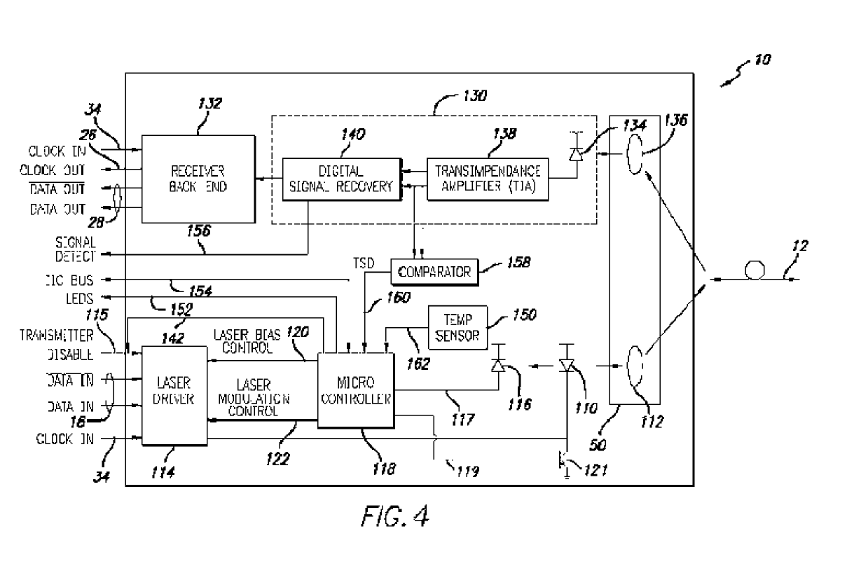

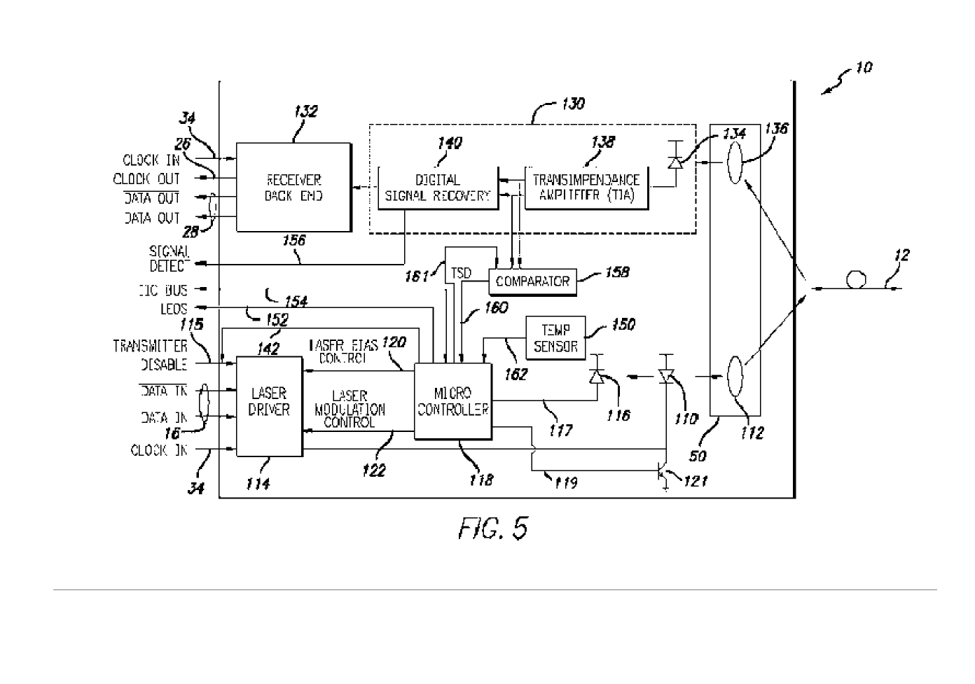

Another aspect of the test mode control using the microcontroller 118 is the ability to adjust power to the laser driver in order to drive the highest possible impulse into the fiber. Laser driver capability maybe sometimes limited due to its output stage to 80 or 100 mA maximum value. Utilizing the features of open loop microcontroller 118, is to control the laser power to maximum for the pulse used to measure reflections. Since the microcontroller 118 controls laser bias and modulation, large power pulses for measurement purpose can be sent. The reflected signal will be higher and can be detected while the threshold level of the comparator is fixed. An additional current drive, beyond the laser driver capability, can be added via a dedicated transistor, schematically depicted as 121 in FIG. 4 that is capable to drive a single pulse current much higher than a laser driver. The transistor 121 is driven by the microcontroller via line 119. The actual laser diode current can be limited, for protection, either by a series resistor in the collector of transistor 121 or by limiting the base current drive from the microcontroller. Since an impulse current can reach 300 mA or more, it will provide significantly more power into the fiber, enhancing the capability to detect reflections. For example under normal data transport operation the power level may be −5 dBm the pulse peak power can be +2 dBm.

Increasing the receiver sensitivity to detect reflected signal is also important. The threshold level of the comparator 158 is sometimes adjusted during manufacturing such that a 14 dB ORL reflection will be below such threshold (called Test Signal Detect threshold) and reflections from an open connector will not be identified during normal operation of the transceiver as a data transport link. In order to enable fault location estimation as described above, and still provide link indication properly during operation, the comparator 158 threshold level must be adjustable. For example, the comparator 158 may be designed so that the level of threshold is controlled by a resistor, (for example post amplifiers are commercially available from Maxim with built in signal detect that is adjustable via changing of a resistor value) and using a variable resistor whose value the microcontroller can adjust (e.g. Maxim MAX5160), both tasks can be achieved. In FIG. 5. line 161 depicts the control line from the microcontroller 118 to the comparator 158 that increases the sensitivity to the maximum possible for the period after the transmission of the high light impulse. Such sensitivity can be −23 dBm. For continuous link operation a higher threshold will be used to avoid open connector reflections. For example, transmitter with −5 dBm output power will receive −20 dBm signal from an open connector located in close proximity. Such connector will reflect −14.5 dB of the power resulting in −19.5 dBm back to the receiver. If the comparator is set to −18 dBm sensitivity, such reflection will not be detected.

For a transceiver that has the improved sensitivity during impulse detection (e.g. −23 dBm) and high output pulse power (e.g. +2 dBm) there is a dynamic range of 25 dB. If an open fiber reflects −15 dB of the incident power another 10 dB can be useful for propagation. For a fiber with 0.5 dB/km attenuation the location of the reflection that will be detected can be as far as 10 km. Transmit +2 dBm, 5 dB attenuation to the fault −15 db reflection and another 5 dB attenuation on the way back will result in −23 dBm which is the sensitivity limit.

Furthermore, instead of sending a light impulse the microcontroller can send a sequence of pulses. Using special cross-correlation to detect the sequence can be utilized to increase the sensitivity even of the receiver.

Therefore, it will be appreciated that the present invention provides an optical transceiver adapted for use in an optical fiber data transmission system which is capable of detecting reflections in fiber connection.

Although the present invention has been described in relation to specific embodiments it should be appreciated that the present invention is not limited to these specific embodiments as a number of variations are possible while remaining within the scope of the present invention. In particular, the specific implementations illustrated are purely exemplary and may be varied in ways too numerous to enumerate in detail. Accordingly they should not be viewed as limiting in nature.

1. An optical transceiver, comprising:
a transmitter comprising a laser diode and a laser driver providing a drive signal to the laser diode;
a receiver comprising a photodiode and signal recovery circuitry; and
a microcontroller coupled to the transmitter and receiver and providing a modulated power control current to the laser during an impulse test mode to transmit high optical power signal and monitoring received signals to detect reflections.

2. An optical transceiver as set out in claim 1, wherein said transmitter and receiver are coupled to same fiber.

3. An optical transceiver as set out in claim 1, wherein said modulated power control is controlling a laser driver that has modulation and bias power control inputs and wherein said microcontroller modulates said bias control input during said test mode.

4. An optical transceiver as set out in claim 1, wherein said microcontroller modulates said power control signal employing a dedicated transistor for direct high current impulse drive of the laser.

5. An optical transceiver as set out in claim 1, wherein said receiver further comprises a transimpedance amplifier coupled to the photodiode and wherein said microcontroller monitors the output of said transimpedance amplifier during said impulse test mode.

6. An optical transceiver as set out in claim 5, further comprising a comparator coupled between the output of said transimpedance amplifier and said microcontroller, for detecting signals at the output of the transimpedance amplifier.

7. An optical transceiver as set out in claim 6, wherein said comparator detection level is controlled during the impulse test mode to be more sensitive than during data transport mode.

8. An optical transceiver as set out in claim 1, wherein the impulse test signal comprise a code sequence.

9. An optical transceiver as set out in claim 1, wherein said microcontroller is capable to detect the code sequence at the output of the comparator.

10. A method for detection of high optical reflection in a fiber optic network, comprising:
transmitting an impulse test signal by modulating a laser transmitter using an impulse test transmission mode which is different than a data transmission mode used during normal operating conditions; and
detecting any received signals modulated using said test transmission mode within a predetermined time period after said transmitting.

11. A method for fault detection in a fiber optic network as set out in claim 10, wherein said test transmission mode comprises modulating the laser at a power level above the minimum threshold for normal data transmission.

12. A method for fault detection in a fiber optic network as set out in claim 10, wherein said test transmission mode comprises modulating the laser at a frequency substantially lower than during normal data transmission.

13. A method for high reflection detection in a fiber optic network as set out in claim 10, further comprising detecting and measuring the time delay for receiving the reflected test pulse and determining the location of the reflection.

14. A method for fault detection in a fiber optic network as set out in claim 10, further comprising increasing the laser transmitter power during transmission of said short duration test pulse.

15. A method for fault detection in a fiber optic network as set out in claim 10, further comprising increasing the detection sensitivity after the transmission of the said short duration test pulse.
